(19) United States
(12) Patent Application Publication
(10) Pub. No.: US 2009/0167047 A1
(43) Pub. Date: Jul. 2, 2009

(54) COCKPIT MODULE AND METHOD FOR INSTALLING SAID COCKPIT MODULE IN A VEHICLE BODY

(75) Inventor: Lionel Peuch, Vastra Frolunda (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/720,654

(22) PCT Filed: Dec. 13, 2004
(86) PCT No.: PCT/SE04/01859

§ 371 Date: Jun. 1, 2007

(51) Int. Cl. B62D 25/14

(52) U.S. Cl. 296/72; 296/70

(57) ABSTRACT

A cockpit module for a vehicle body includes a driver interface such as a steering wheel and a driver information display. The cockpit module is substantially non-self-supporting prior to installation in the vehicle body and is adapted to be structurally supported externally at one or more external support surfaces by at least one structural beam of the vehicle body once installed in the vehicle body. The cockpit module is suitably adapted to be structurally supported externally by an external carrier frame at one or more further external support surfaces during installation until it is secured to the vehicle body.

### BACKGROUND AND SUMMARY

The present invention relates to a cockpit module and a method for installing said cockpit module in a vehicle body, and in particular in a cab for a cargo carrying truck. The cockpit module comprises driver interface means such as a steering wheel and a driver information display, and the method comprises use of a carrier frame for carrying the cockpit module during installation.

In modern, efficient production of vehicles, and in this case more particularly a cab for a truck, it is common to assemble sub-assemblies prior to final installation in the vehicle. One such assembly is the cockpit module, which may include driver interface means such as steering wheel and driver displays of various types. Thus, it is well known per se to install a pre-assembled cockpit module into the cab.

Normally, the cockpit module comprises an outer shell of a suitable plastic material supported by a metal reinforcement, and is structurally held together by means of an integrated internal frame structure. Traditionally, this internal frame structure includes sheet metal braces and consoles which supports the outer shell and the components within the cockpit modules. The internal frame structure makes the cockpit structurally self-supporting during installation and thus facilitates the handling of it until it is finally installed in the cab. The cockpit module may in this way be carried in a simple mounting jig or carrier frame until it is secured in the vehicle. However, this internal frame structure also adds weight and cost to the cockpit module, which is a disadvantage in modern production.

According to an aspect of the present invention a cockpit module is provided in which the internal frame has been eliminated completely. This is achieved by utilizing the strength of at least one structural beam of the vehicle body to support the cockpit module once installed in said vehicle body, so as to eliminate the need for superfluous internal support structures within the cockpit module. In this way, both weight and production cost are saved.

More particularly, the invention discloses a cockpit module for a vehicle body, comprising driver interface means such as a steering wheel and a driver information display. The invention is especially characterized in that the cockpit module is substantially non-self-supporting prior to installation in the vehicle body and is adapted to be structurally supported externally at one or more external support surfaces, by at least one structural beam of the vehicle body once installed in said vehicle body.

In an advantageous embodiment of the invention, the cockpit module is adapted to be structurally supported externally by an external carrier frame at one or more further external support surfaces during installation until it is secured to the vehicle body.

In one embodiment, the carrier frame is provided with access openings, the positions of which correspond to predefined points of attachment between the cockpit module and said one or more structural beams of the vehicle body.

In a suitable embodiment, the carrier frame includes one or more sub-frame portions which are movably hinged to the remaining carrier frame for engaging or disengaging the cockpit module.

Preferably, the carrier frame is adjustable to cockpit modules of varying dimensions, by means of one or more telescopic frame sections.

In a suitable embodiment, the vehicle body is a cab for a cargo carrying truck.

The invention also provides a method for installing a cockpit module in a vehicle body, said cockpit module comprising driver interface means such as a steering wheel and a driver information display. The method comprises use of a carrier frame for carrying said cockpit module during installation, said carrier frame being releasably attached to the cockpit module. The method is especially characterized in the steps of:
attaching said carrier frame as a structural external support for the cockpit module during installation, said cockpit module being substantially non-self supporting prior to completed installation in the vehicle body;
fastening the cockpit module to the vehicle body in such a way that it is structurally supported externally at one or more external support surfaces, by at least one structural beam of the vehicle body, and
releasing the carrier frame from the installed cockpit module.

In one embodiment of the invention, the carrier frame is opened or closed for engaging or disengaging the cockpit module, by means of one or more sub-frame portions which are movably hinged to the remaining carrier frame.

Further features and advantages of the invention will be described in the detailed description of embodiments below.

### BRIEF DESCRIPTION OF THE DRAWINGS

The invention will now be described in greater detail by way of example only and with reference to the attached drawings, in which

FIG. 1 shows a schematic view of a truck cab with a cockpit module according to the invention, being installed by means of an external carrier frame, also according to the invention, and

FIG. 2 shows a perspective view of a cockpit module carried by an external carrier frame.

### DETAILED DESCRIPTION

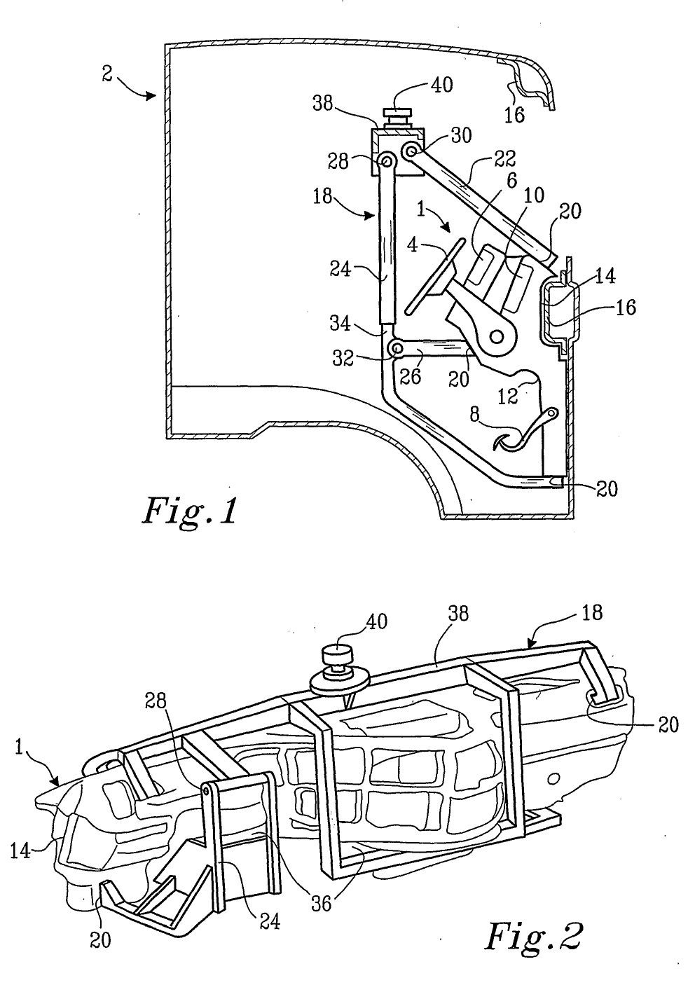

In FIG. 1, reference numeral 1 denotes a cockpit module for a vehicle body 2, here in the form of a cab for a cargo carrying truck (not shown). The vehicle body 2 is in a stripped, so called “body-in-white” condition, with no sub-assemblies yet installed on it. The cockpit module 1 comprises driver interface means such as a steering wheel 4 and a driver information display 6. In the shown exemplary embodiment, the cockpit module further includes a pedal assembly 8 and an electronic control unit 10 for example controlling the suspension characteristics of the vehicle (not shown). Naturally, the cockpit module 1 may include many other units not described herein, but these are not further described since they are well known within the automotive industry and readily apparent for a skilled man in the art. It should be noted that both the cockpit module 1 and the vehicle body 2 is drawn schematically, with many details omitted for the sake of focussing on the present invention.

As shown in FIG. 1, the cockpit module 1 comprises an outer shell 12 of a suitable plastic material. As opposed to known cockpit modules (not shown), the cockpit module 1 of the invention is substantially non-self-supporting prior to installation in the vehicle body 2. The term “substantially non-self-supporting” here simply means that the cockpit module 1 naturally has some stiffness and rigidity due to its design and material characteristics, but it lacks the major internal frame structures including sheet metal braces and consoles (not shown) which—in prior art cockpit modules—supports the outer shell 12 and the components within the cockpit module 1. Instead, according to the present invention, the cockpit module 1 is adapted to be structurally supported externally at one or more external support surfaces 14, by at least one structural beam 16 of the vehicle body 2 once the cockpit module 1 is installed in said vehicle body 2. In this way, the cockpit module 1 according to the invention utilizes the strength of said at least one structural beams 16—preferably the windshield beam as in this case—to eliminate the need for superfluous internal support structures (not shown) within the cockpit module 1, which saves both weight and production cost in a favorable manner.

Another feature of the present invention is that the non-self-supporting cockpit module 1 is adapted to be structurally supported externally by an external carrier frame 18 at one or more further external support surfaces 20 until it is secured to the vehicle body 2.

The external carrier frame 18 includes one or more sub-frame portions 22, 24, 26 which are movably hinged at pivot axles 28, 30 and 32 respectively, to the remaining carrier frame 18 for engaging or disengaging the cockpit module 1.

In the embodiment shown in FIG. 1, the carrier frame 18 is adjustable to cockpit modules 1 of varying dimensions (only one type shown), by means of one or more extendable telescopic frame sections 34.

As shown in the embodiment of FIG. 2, the carrier frame 18 is provided with access openings 36, the positions of which correspond to predefined points of attachment (not shown since they are on the reverse side) between the cockpit module 1 and said one or more structural beams 16 of the vehicle body 2.

In both shown embodiments, the carrier frame 18 has a longitudinal main beam 38 extending along the cockpit module 1. This longitudinal main beam 38 is provided with one or more lifting interface means 40, allowing the carrier frame 18 to be easily handled in production.

The method according to the invention comprises use of the carrier frame 18 for carrying said cockpit module 1 during installation. The method comprises the steps of:
attaching said carrier frame 18 as a structural external support for the cockpit module 1 during installation, said cockpit module 1 being substantially non-self-supporting prior to completed installation in the vehicle body 2;
fastening the cockpit module 1 to the vehicle body 2 in such a way that it is structurally supported externally at one or more external support surfaces 14, by at least one structural beam 16 of the vehicle body 2, and—releasing the carrier frame 18 from the installed cockpit module 1.

It is to be understood that the invention is by no means limited to the embodiments described above, and may be varied freely within the scope of the appended claims.

### LIST OF REFERENCE NUMERALS

1. Cockpit module
2. Vehicle body
4. Steering wheel
6. Driver display
8. Pedal assembly
10. Electronic control unit
12. Outer shell of cockpit module
14. External support surfaces
16. Structural beam of the vehicle body
18. External carrier frame
20. Further external support surfaces
22. Sub-frame portion
24. Sub-frame portion
26. Sub-frame portion
28. Pivot axle
30. Pivot axle
32. Pivot axle
34. Telescopic frame section
36. Access openings corresponding to predefined points of attachment
38. Longitudinal main beam of carrier frame
40. Lifting interface means

1. A cockpit module for a vehicle body, comprising
a driver interface and a driver information display, the cockpit module being substantially non-self-supporting prior to installation in the vehicle body and being adapted to be structurally supported externally at one or more external support surfaces by at least one structural beam of the vehicle body once installed in the vehicle body.

2. A cockpit module according to claim 1, wherein the cockpit module is adapted to be structurally supported externally by an external carrier frame at one or more further external support surfaces during installation until it is secured to the vehicle body.

3. A cockpit module according to claim 2, wherein the carrier frame is provided with access openings, the positions of the access openings corresponding to predefined points of attachment between the cockpit module and the at least one structural beam.

4. A cockpit module according to claim 2, wherein the carrier frame includes at least one sub-frame portion, the at least one sub-frame portion being movably hinged to the carrier frame for engaging or disengaging the cockpit module.

5. A cockpit module according to claim 2, wherein the carrier frame is adjustable to cockpit modules of varying dimensions by means of at least one telescopic frame section.

6. A cockpit module according to claim 1, wherein the vehicle body is a cab for a cargo carrying truck.

7. Method for installing a cockpit module in a vehicle body, the cockpit module comprising driver interface means such as a steering wheel and a driver information display, the method comprising
using a carrier frame for carrying the cockpit module during installation, the carrier frame being releasably attached to the cockpit module;
attaching the carrier frame as a structural external support for the cockpit module during installation, the cockpit module being substantially non-self-supporting prior to completed installation in the vehicle body;
fastening the cockpit module to the vehicle body so that it is structurally supported externally at at least one external support surface by at least one structural beam of the vehicle body; and
releasing the carrier frame from the installed cockpit module.

8. Method according to claim 7, wherein the carrier frame is opened or closed for engaging or disengaging the cockpit module by at least one sub-frame portion which is movably hinged to the remaining carrier frame.

9. Method according to claim 8, wherein the carrier frame is adjustable to cockpit modules of varying dimensions, by at least one telescopic frame section.

10. Method according to claim 7, wherein the vehicle body is a cab for a cargo carrying truck.

11. Method according to claim 7, wherein the carrier frame is adjustable to cockpit modules of varying dimensions, by at least one telescopic frame section.

12. A cockpit module according to claim 3, wherein the carrier frame includes at least one sub-frame portion, the at least one sub-frame portion being movably hinged to the carrier frame for engaging or disengaging the cockpit module.

13. A cockpit module according to claim 12, wherein the carrier frame is adjustable to cockpit modules of varying dimensions by means of at least one telescopic frame section.

14. A cockpit module according to claim 3, wherein the carrier frame is adjustable to cockpit modules of varying dimensions, by means of at least one telescopic frame section.
